(19) United States
(12) Patent Application Publication
(10) Pub. No.: US 2015/0296854 A1
(43) Pub. Date: Oct. 22, 2015

(54) METHOD FOR MANUFACTURING A FISH SAUCE AND A FISH SAUCE PREPARED BY THE SAME

(71) Applicant: CJ CHEILJEDANG CORPORATION, Seoul (KR)

(72) Inventors: Ho Woo LEE, Seoul (KR); Ji Young OH, Gyeonggi-do (KR); Dae Ik KANG, Gyeonggi-do (KR)

(21) Appl. No.: 14/690,518

(22) Filed: Apr. 20, 2015

(30) Foreign Application Priority Data
Apr. 18, 2014 (KR) 10-2014-0046725

(51) Int. Cl. A23L 1/313

(52) U.S. Cl. CPC A23L 1/313

(57) ABSTRACT

A method for manufacturing a high-flavor fish sauce within a short period of time and a fish sauce prepared by the method. The method for manufacturing a fish sauce includes fermenting a salted marine product for the first time and then performing fermentation/ripening under a constant-temperature condition after adding a crude fish sauce, and can considerably reduce the long fermentation and ripening period, which is 1-3 years or longer, of the traditional method. Also, since the fish sauce prepared by the method for manufacturing a fish sauce has improved nutrient content and taste, with reduced characteristic fishy odor and improved sensory flavor and quality, it is highly competitive and can be widely used in the fish sauce manufacturing industry.

### CROSS-REFERENCE TO RELATED APPLICATION

This application claims priority to Korean Patent Application No. 10-2014-0046725, filed on Apr. 18, 2014, and all the benefits accruing therefrom under 35 U.S.C. §119, the contents of which in its entirety are herein incorporated by reference.

### BACKGROUND

1. Field

The present invention relates to a method for manufacturing a high-flavor fish sauce within a short period of time and a fish sauce prepared by the method. More specifically, the present invention relates to a method for manufacturing a fish sauce by mixing a crude fish sauce with salting ingredients at a predetermined ratio and fermenting and ripening the mixture under a constant-temperature condition, and a fish sauce prepared therefrom.

2. Description of the Related Art

Fish sauce is a food obtained by fermenting marine products which are good nutritional sources of calcium. It is consumed as it is or has been used as a staple material in making kimchi. In Southeast Asia, fish sauce is widely used as a condiment and a sauce. Therefore, the fish sauce is a very important foodstuff for Koreans and Southeast Asians. In addition, jeotgals including the fish sauce are Korean traditional fermented foodstuffs used in making many Korean foods. Generally, existing fish sauces are prepared by mixing marine products with salt and ripening the mixture for a long period of time. However, the ripening of the fish sauces for a long period of time often leads to the intrinsic fishy odor of the marine products, resulting in repulsive taste and making the foods prepared using the fish sauce limited due to the fishy odor. Although the fish sauces are used in various cuisines in Southeast Asia, it is primarily used as a subsidiary ingredient when making kimchi in Korea. In Korea, marine products are salted and fermented for use as fermented seafood, condiments or subsidiary ingredients for making kimchi. The fermented seafood is usually prepared by adding a large amount of salt, followed by fermentation and ripening, as the proteins contained in the raw materials are degraded by the action of proteases contained therein. The fish sauces refer to a liquid extract separated from the jeotgal after further fermenting for a long period of time.

Jeotgals and fish sauces manufactured using marine products can provide a deep and savory taste due to ripening by enzymatic activity along with the unique flavor of the marine product itself, and are usually used as seasonings for appetizers. In fact, jeotgals and fish sauces are used as subsidiary ingredients for making seaweed soup, seasoned zucchini, and kimchi. In Korea, various kinds of jeotgals are manufactured in different parts of the country, and also various kinds of kimchi prepared using the same are available. Recently, with the globalization of food materials, fish sauces with similar taste are being imported as foodstuff from overseas, including Southeast Asian countries.

Conventional fish sauces contain water, salt, and a small amount of amino acids, nitrogen, and calcium. An anchovy fish sauce, which is a representative fish sauce, contains a large amount of various amino acids, including glutamic acid, aspartic acid, glycine, alanine, lysine, etc., and seasoning ingredients such as nucleic acids, and thus it has been widely used in seasoning foods such as kimchi (cabbage kimchi, young radish kimchi, leaf mustard kimchi, etc.) and stir-fried foods.

Traditionally, these fish sauces were mainly manufactured at home and consumed in a self-sufficing manner, but nowadays they are being produced in large-scale factories as hygienic products with improved preservability, and there is a growing demand for the fish sauces.

According to a traditional method for manufacturing the fish sauce, a marine product is mixed with salt, put into a tank or a container, and then allowed to ferment for a certain period of time (at least 24 months). Then, the resulting liquid produced as the proteins of the marine product are broken down is filtered to obtain the fish sauce. The fish sauce manufactured using the marine product as a raw material, being a natural animal-derived natural seasoning, has been used as a condiment essential for making kimchi, and also in cooking of other foods in Korea, and thus has become one of the seasonings essential in the Korean food culture.

When the fermentation is performed by the traditional method, a longer period of time is required for fermentation/ripening, during which the proteins of the marine product are degraded by autolytic enzymes contained in the marine product, and they are also degraded by various microorganisms which can grow under high salt conditions. Generally, the fermentation is affected by kinds and states of the microorganisms involved, and contamination by various bacteria is often accompanied foul odor and unpleasant taste.

Recently, there has been an increase in the production of a fish sauce using sand lance which has no strong fishy odor. But, when the sand lance sauce is manufactured according to the traditional method like the anchovy fish sauce, it can be used only in foods having a strong smell such as kimchi due to its foul odor and taste.

Additionally, because the traditional method requires a long period of time, it is difficult to achieve good productivity and competitiveness, which makes an obstacle in its progress in the related industry. Accordingly, various attempts have been made to shorten the fermentation period of the conventional fish sauces. For example, Korean Patent No. 10-0467500 suggests a method for manufacturing a fish sauce, which includes adjusting pH, ripening 3 times by adding an enzyme, sterilizing and filtering. Additionally, Korean Patent No. 10-0034142 discloses a method for manufacturing a fish sauce, which includes adding a calcium salt as an enzyme activity enhancer and a protease to ground meat, agitating at optimum pH and temperature conditions for 4 hours, hydrolyzing, sterilizing, cooling, filtering, and adding salt to the filtrate.

### SUMMARY

The inventors of the present invention, while endeavoring to develop a method for manufacturing a fish sauce having high quality and flavor with high competitiveness within a shortened period of time given the problems occurring in the prior art, discovered that a fish sauce with high quality and superior flavor can be rapidly manufactured within a short period of time (between 15 days and 5 months) by a method including mixing a ground marine product with salt, homogenizing the mixture, performing first fermentation, mixing the resultant with a crude fish sauce, placing in a sealed container, and ripening by performing second fermentation at constant temperature under an air-conditioned environment, whereby the proteins contained in the marine product are degraded by the autolytic enzyme contained in the marine product, thereby completing the present invention.

Furthermore, they confirmed that a crude fish sauce and a fish sauce with high quality and flavor can be manufactured also with a relatively longer period (6-12 months or longer) of fermentation/ripening by a method including mixing a ground marine product with salt and homogenizing the mixture, performing first fermentation, mixing the resultant with a crude fish sauce, placing in a sealed container, and ripening by performing second fermentation at constant temperature under an air-conditioned environment, whereby the proteins contained in the marine product are degraded by the autolytic enzyme contained in the marine product.

An objective of the present invention is directed to providing a method for manufacturing a high-flavor fish sauce within a short period of time.

Another objective of the present invention is also directed to providing a fish sauce prepared by the method.

### Advantageous Effects

The method for manufacturing a fish sauce of the present invention can considerably reduce the long fermentation and ripening period, which is 1-3 years or longer, of the traditional method, can improve the nutrient content and taste through the addition of the crude fish sauce, can remove the characteristic fishy odor, and can enhance its sensory flavor and quality. Accordingly, the method is highly competitive and can be widely used in the fish sauce manufacturing industry.

### BRIEF DESCRIPTION OF THE DRAWING

FIG. 1 is a schematic diagram illustrating a method for manufacturing a fish sauce according to an exemplary embodiment of the present invention.

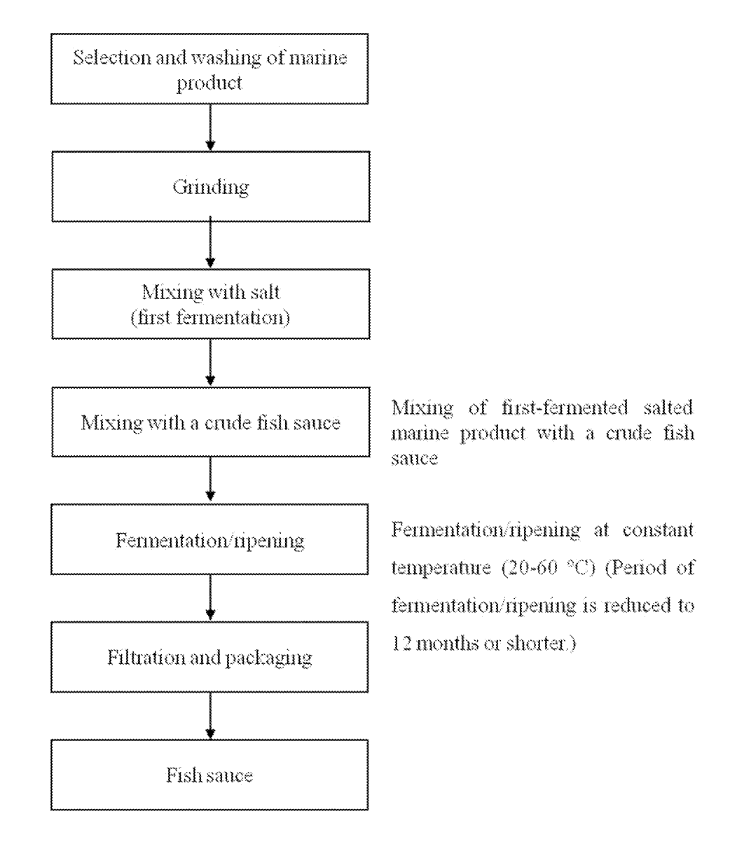

### DETAILED DESCRIPTION

In an aspect, the present invention provides a method for manufacturing a high-flavor fish sauce within a short period of time. Specifically, the present invention provides a method for manufacturing a fish sauce, including the steps of: (a) adding salt to a ground marine product or a marine product, and mixing and homogenizing the mixture; (b) performing first fermentation of the mixed homogenate obtained in step (a); (c) adding a crude fish sauce to the first fermentation product obtained in step (b) and mixing the mixture; and (d) ripening the mixture obtained in step (c) by performing fermentation.

Specifically, the present invention provides a method for manufacturing a fish sauce wherein, in the step (d), the mixture obtained in the step (c) is ripened by performing fermentation at constant temperature. In addition, the present invention provides a method for manufacturing a fish sauce wherein, in the step (d), the mixture obtained in the step (c) is ripened by performing fermentation in an airtight sealed container at constant temperature.

Specifically, the present invention may provide a method for manufacturing a fish sauce, including the steps of: (a) adding salt to a ground marine product or a marine product, and mixing and homogenizing the mixture; (b) performing first fermentation of the mixed homogenate obtained in the step (a); (c) adding a crude fish sauce to the fermentation product obtained in the step (b) and mixing the mixture; and (d) ripening the mixture obtained in the step (c) by performing second fermentation in an airtight sealed container under a medium temperature (20-60° C.) condition for from 15 days to 1 year.

In addition, the present invention provides a method for manufacturing a fish sauce which maintains high flavor even after being ripened by performing fermentation for a long period of time. Specifically, the present invention provides a method for manufacturing a fish sauce, including the steps of: (a) adding salt to a ground marine product or a marine product, and mixing and homogenizing the mixture; (b) performing first fermentation of the mixed homogenate obtained in the step (a); (c) adding a crude fish sauce to the fermentation product obtained in the step (b) and mixing the mixture; and (d) ripening the mixture obtained in the step (c) by performing second fermentation in an airtight sealed container under a constant temperature condition of 5-30° C. for 6 months or longer or for 12 months or longer.

Specifically, the method for manufacturing a fish sauce of the present invention can further include, before the step (a), the steps of: (i) removing water from a washed marine product; and (ii) grinding or not grinding the water-removed marine product.

Specifically, the method for manufacturing a fish sauce of the present invention can further include, after step (d), heat-treating the fish sauce manufactured in step (d) at 60-100° C. for 10-30 minutes and then cooling.

In the present invention, the “fish sauce” refers to a fermentation product of animal proteins and is also called a fish paste. Specifically, the animal protein may be derived from marine product. Examples of the marine product may include fish, crustaceans, and cephalopods, etc. More specifically, they may include pacific sand lance, anchovy, horse mackerel, squid, octopus, mackerel pike, sardine, tuna, tuna cooking juice, shrimp, Mysidae, Japanese ice fish, herring, gizzard shad, mackerel, Trachurus japonicus, yellowtail, pond smelt, or a combination thereof, more specifically, anchovy or pacific sand lance, although not being limited thereto.

In the present invention, the term “crude fish sauce” refers to a crude liquid obtained by fermenting and ripening a salted marine product, a filtrate of the crude liquid, or a mixture obtained by adding salt to a marine product, performing first fermentation thereof and then adding the crude fish sauce prepared as described above. Traditionally, anchovy or pacific sand lance is used to prepare the crude fish sauce. Occasionally, however, horse mackerel, squid, octopus, mackerel pike, sardine, tuna, tuna cooking juice, shrimp, Mysidae, Japanese ice fish, herring, gizzard shad, mackerel, Trachurus japonicus, yellowtail, pond smelt, or a combination thereof may be used, although not being limited thereto. In an exemplary embodiment of the present invention, a crude anchovy fish sauce obtained by placing mixture of 10 kg of anchovy and 2.5 kg of salt in a container, fermenting for 6-12 months or longer, and filtering the fermentation product was used.

The method for manufacturing a fish sauce of the present invention is advantageous in that, by performing first fermentation of a mixed homogenate of a marine product and salt, adding a crude fish sauce thereto and then performing fermentation in an airtight sealed container under a constant-temperature condition, the fermentation period can be reduced to half or less as compared to the traditional method for manufacturing a fish sauce.

Specifically, in the present invention, a mixture of a marine product, salt and a crude fish sauce may be fermented and ripened in an airtight tank or container. Specifically, the fermentation according to the present invention may be performed in an airtight fermentation container maintained at constant temperature under an air-conditioned environment.

In addition, the present invention provides a method for manufacturing a fish sauce with improved quality (total nitrogen, TN) over the existing fish sauces, by adding a crude fish sauce at a predetermined ratio. Furthermore, the fish sauce manufactured according to the method of the present invention can have improved quality over the existing fish sauces even when the fish sauce is manufactured through a relatively longer ripening period.

The fish sauce manufactured via rapid fermentation using hot air or warm air exhibits improved taste quality in terms of savory taste, sweetness and compatibility, and has no difference in taste and nutrient contents, compared to those of the traditional fish sauce. Accordingly, it is expected that the method according to the present invention can upgrade the competitiveness of traditional Korean fermented seafood.

An exemplary embodiment of the method for manufacturing a fish sauce according to the present invention may be specifically as follows.

A. Washing of Marine Product

A marine product is washed 2-3 times with water. The marine product that can be used to manufacture a fish sauce in the present invention may include pacific sand lance, anchovy, horse mackerel, squid, octopus, mackerel pike, sardine, tuna, tuna cooking juice, shrimp, Mysidae, Japanese ice fish, herring, gizzard shad, mackerel, Trachurus japonicus, yellowtail, pond smelt, or a combination thereof, specifically anchovy or pacific sand lance, although not being limited thereto.

The washing may be performed using clean purified water, or seawater.

B. Removal of Water

After the washing is completed, water can be removed from the washed marine product, specifically, within a short period of time of 30 minutes or less.

C. Grinding of Marine Product

The water-removed marine product is ground sufficiently to a size of 0.5-1.5 cm before being mixed with salt in a mixer. The grinding facilitates action by enzymes and microorganisms, thereby accelerating degradation of proteins. However, the marine product may also be used as it is without being ground.

D. Addition of Salt to Marine Product, Mixing and Homogenization

After salt is added to the ground marine product or the marine product, the mixture is mixed and homogenized. The salt can be added in an amount of 17-30% (w/w) based on the weight of the ground marine product or the marine product. Salt is added to prevent decay of the marine product during fermentation at medium temperature in the following step. When the amount of the added salt is less than 17% (w/w), it is not sufficient to prevent the decay of a fish sauce. In contrast, when the amount of the added salt is greater than 30% (w/w), it will lower the preference as food and may also cause a health problem caused by excessive salt intake.

Accordingly, the salt can be added in an amount of 17-30% (w/w) based on the weight of the ground marine product or the marine product to prevent decay while avoiding excessive salt intake. Additionally, both commercially available refined salt and solar salt can be used as the salt of the present invention. Specifically, solar salt from which more than 90% water has been removed can be used.

The marine product and the salt can be mixed and homogenized using a screw.

E. First Fermentation of Salted Marine Product

The marine product uniformly mixed in the above step (mixed homogenate) is contained in an airtight (sealed) container and fermented for the first time. The first fermentation of the present invention may be performed at 20-30° C. for 1 day or longer, specifically for from 1 day to 3 months after placing the mixed homogenate in an airtight sealed container.

The sealed container used in the present invention may be any airtight sealed container. For example, it may be selected from a group consisting of a polyethylene (PE) tank, a stainless steel tank, a fiber-reinforced plastic (FRP) tank, an earthenware, a glass container and a plastic container.

F. Addition of Crude Fish Sauce to First-Fermented Salted Marine Product and Mixing

A crude fish sauce is added to and then mixed with the salted marine product which has been first-fermented in the above step. The crude fish sauce may be added in an amount of 1-30% (w/w) based on the weight of the mixed homogenate. This facilitates the degradation of the proteins contained in the marine product by autolytic enzymes during fermentation at medium temperature in the following step, thereby reducing the characteristic fishy odor and providing a high-flavor crude fish sauce.

G. Second Fermentation/Ripening

After the crude fish sauce has been added and mixed, the mixture is subjected to a fermentation/ripening process at constant temperature, specifically at medium temperature. Unlike the traditional method, the fermentation of the fish sauce in the present invention can be performed at medium temperature. The medium temperature is 20-60° C., specifically 40-50° C. The medium temperature may be constantly maintained using hot or warm air under an air-conditioned environment, although not being limited thereto.

Additionally, in the present invention, the fermentation at the medium temperature is performed for from 15 days to 1 year, specifically for from 15 days to 5 months, and more specifically for 1-3 months. Although this period is considerably shorter when compared with the existing method for manufacturing a fish sauce, which is 1-3 years, there is no difference at all in terms of nutrient contents and flavor of the fish sauce from those manufactured according to the existing method. Rather, it was confirmed that the addition of the crude fish sauce resulted in improved sensory flavor and quality including increase in protein content, improvement of savory taste and sweetness, reduction of the degree of decay, elimination of the characteristic fishy odor of fish sauce, etc. (Tables 1 to 3).

And, after the crude fish sauce has been added and mixed, the mixture may be subjected to fermentation/ripening at constant temperature, which is lower than the medium temperature, more specifically at a constant temperature of 5-30° C., for 6 months or longer, specifically for 6-12 months.

Additionally, in the present invention, the fish sauce, after the fermentation/ripening, can be heat-treated at 60-100° C. for 10-30 minutes and then cooled.

H. Obtainment of Filtrate

Subsequently, precipitates are removed from the fermented liquid produced in the fermentation/ripening tank and the supernatant is separated, settled, and filtered. The resulting filtrate is used to manufacture the fish sauce according to the present invention. The filtration method to be used in the present invention can be any conventional filtration method used in the art. Specifically, the filtration may be performed by filtrating the fermented liquid using a 1.0 μm filter.

As described in the Examples section, an anchovy fish sauce manufactured according to the existing traditional method and one manufactured according to the method of the present invention were compared in their contents of total nitrogen and amino nitrogen as nutrients. As a result, it was confirmed that, although the fermentation period was the same, the contents of total nitrogen and amino nitrogen in the fish sauce manufactured according to the present invention were much higher (Table 1). Accordingly, the inventors of the present invention were convinced when a fish sauce is manufactured according to the present invention, that the period of time required to manufacture the fish sauce can be considerably reduced and that the nutrient contents can be remarkably increased when it is fermented for the same period of time.

In addition, it was confirmed that the fish sauce manufactured according to the present invention exhibits superior flavor although it was manufactured within a shorter period of time than that manufactured by the existing method. As described in the Examples section, when the fish sauce manufactured according to the existing traditional method and that manufactured according to the method of the present invention were compared, it was confirmed that there was a significant difference between the two fish sauces in terms of sensory evaluation factors such as salty taste, savory taste, flavor, overall preferences, etc. (Table 3). It is considered that the addition of the crude fish sauce under a constant temperature condition resulted in improved sensory flavor as compared to the existing fish sauce, due to elimination of the characteristic fishy odor of fish sauce, and improved savory taste sweetness, intrinsic flavor, etc.

Accordingly, when a fish sauce is manufactured according to the present invention, the period of time required to manufacture the fish sauce can be considerably reduced and the flavor quality of the fish sauce can be improved over the existing fish sauce.

In an additional aspect, the present invention provides a fish sauce manufactured by the method for manufacturing a fish sauce of the present invention. The fish sauce manufactured by the method for manufacturing a fish sauce of the present invention is advantageous in that it can be manufactured within a shorter period of time, and that it is competitive in the market due to improved flavor quality, as compared to the existing fish sauce.

In general, the fish sauce of the present invention can be added, without limitation, to foods to which a fish sauce is added, such as kimchi, seasoned vegetables, stir-fried foods, soups, marinated crabs, etc. That is, the fish sauce of the present invention can be typically used in making kimchi, and can also be used in various kinds of side dishes such as seasoned vegetables and stir-fried foods. The fish sauce of the present invention provides improved sensory flavor due to the elimination of the characteristic fishy odor of fish sauce, improved savory taste and sweet taste, etc., as compared to the existing fish sauces, and thus can be used in a wider variety of foods without being limited for use as a condiment in making kimchi or other limited foods. Additionally, the fish sauce of the present invention can contribute to the development of the marine products industry and the food industry as well as to an increased income for fishermen involved in the manufacture of fish sauces.

### EXAMPLES

Hereinafter, the present invention will be described in detail through examples. However, the following examples are for illustrative purposes only and the scope of the present invention is not limited by the examples.

### Example 1

### Manufacture of Anchovy Fish Sauce

1-1. Preparation of Raw Materials

Anchovy, a fish representatively used in manufacturing fish sauces, was used to manufacture a fish sauce of the present invention. Specifically, fresh anchovies with a size of 9-13 cm caught in Goseong-gun, Gyeongsangnam-do, Korea were purchased for use.

And, a crude fish sauce used in making the fish sauce of the present invention was prepared by washing 10 kg of anchovy for 2-3 times, removing impurities and immersing in water, removing water and homogenizing after mixing with 2.5 kg of salt, fermenting and ripening for 6-12 months or longer, and filtering the resulting fish sauce.

1-2. Preparation of Fish Sauce

The purchased anchovies were washed 2 times with seawater, placed on a net for 30 minutes to drain water, and ground to a size of 0.5-1.0 cm or greater. Then, 30 kg of the ground anchovies were added with 9 kg of solar salt, mixed and homogenized, and then fermented for the first time in an airtight sealed container at 20-30° C. for from 1 day to 3 months. After adding 11 kg of the crude fish sauce prepared to the fermentation product, the mixture was homogenized.

After the homogenization was completed, the homogenate was placed into a 50 L fiber reinforced plastic (FRP) container. The container was covered with a lid to prevent decay due to air introduced from outside, and fermentation/ripening was performed for 4 months at a constant temperature of about 40-50° C. by supplying hot air under an air conditioning system.

Meanwhile, for comparison with the fish sauce of the present invention, a control fish sauce was manufactured as follows. After adding 11.5 kg of solar salt to 38.5 kg of the ground anchovy prepared above, the mixture was homogenized without adding a crude fish sauce. After the homogenization was completed, the homogenate was placed into a 50 L FRP container. The container was covered with a lid to prevent decay due to air introduced from outside, and fermentation/ripening was performed for 12 months at room temperature.

### Example 2

### Comparison of Nutrients in Anchovy Fish Sauces

With the anchovy fish sauce manufactured via rapid fermentation according to Example 1 of the present invention as a test group and the anchovy fish sauce manufactured via traditional fermentation as a control group, the contents of the nutrients contained therein and their degree of fermentation were measured.

Specifically, the contents of total nitrogen (TN) and amino nitrogen (AN), which can serve as criteria for determining the nutrient content and degree of fermentation, were measured. The content of total nitrogen was measured according to the Kjeldahl method and the content of amino nitrogen was measured according to the formol titration method.

The Kjeldahl method is carried out as follows. A sample is added with sulfuric acid, heat-concentrated to decompose organic nitrogen, added with an alkali solution to free the ammonium salt into NH₃. And then, NH₃ is allowed to be absorbed by an acidic solution. Then, the absorbed NH₃ is quantitated via titration to determine the nitrogen content.

And, the formol method is carried out as follows. When an amino acid is maintained at about pH 9, equilibration is achieved in the state of “NH₃+CH(R)COO⁻ (state 1)<=>NH₂+CH(R)COO⁻H⁺ (state 2)”. Then, when formaldehyde is added, the amino acid in the state 2 reacts with formaldehyde and generates another compound. As a result, the reaction proceeds from the state 1 toward the state 2 in order to maintain the equilibration, during which hydrogen ions are released. The hydrogen ions released at about pH 9 are titrated with an alkali to quantitate the amino acid.

The results of measuring total nitrogen and amino nitrogen by the Kjeldahl method and the formol method are shown in Table 1 below.

TABLE 1
Comparison of quality of anchovy fish sauce depending
on fermentation method by fermentation period

| | Total nitrogen (TN) | | Amino nitrogen (AN) | |
|---|---|---|---|---|
| Fermentation | (g/100 mL) | | (mg/100 mL) | |
| period | Control Group | Test group | Control Group | Test group |
| (months) | (room temp.) | (constant temp., 45° C.) | (room temp.) | (constant temp., 45° C.) |
| 1 | 1.48 | 1.90 | 150.98 | 874 |
| 2 | 1.65 | 1.96 | 300.25 | 991 |
| 3 | 1.78 | 2.20 | 395.78 | 1134 |
| 5 | 1.83 | — | 615.42 | — |
| 8 | 1.99 | — | 915 | — |
| 12 | 2.13 | — | 1092.56 | — |

As shown in Table 1, the anchovy fish sauce manufactured via rapid fermentation according to the method of the present invention (test group) showed a rapid increase in the contents of total nitrogen and amino nitrogen as compared to the anchovy fish sauce manufactured according to the existing traditional method (control group).

Specifically, the anchovy fish sauce of the present invention manufactured by rapid fermentation at a constant temperature of 45° C. (test group) showed 2.20 (g/100 mL) of total nitrogen and 1134.00 (mg/100 mL) of amino nitrogen in 3 months after fermentation, which were rather higher than those of the anchovy fish sauce manufactured by fermenting at room temperature for 12 months according to the traditional method (control group), 2.13 (g/100 mL) of total nitrogen and 1092.56 (mg/100 mL) of amino nitrogen.

Also, the contents of total nitrogen and amino nitrogen were compared for the same period. For example when the fermentation was performed for 3 months, the anchovy fish sauce of the present invention which was fermented at constant temperature (45° C.) (test group) showed 2.20 (g/100 mL) of total nitrogen and 1134.00 (mg/100 mL) of amino nitrogen, whereas the anchovy fish sauce manufactured by fermenting at room temperature for 3 months according to the traditional method showed 1.78 (g/100 mL) of total nitrogen and 395.78 (mg/100 mL) of amino nitrogen. Therefore, it was confirmed that that the anchovy fish sauce of the present invention had much higher nitrogen contents.

These results imply that the method of the present invention, wherein a salted marine product is fermented for the first time and then subjected to fermentation/ripening at constant temperature after adding a crude fish sauce, can reduce the fermentation period to half or less of the period required for the traditional method of fermenting at room temperature and, furthermore, can increase the contents of total nitrogen and amino nitrogen, which are important nutrient components contained in the fish sauce, over the same fermentation period. Accordingly, the superior effect and high industrial value of the present invention were confirmed.

### Example 3

### Comparison of Histamine Content in Anchovy Fish Sauces

Although histamine is relatively unharmful to the human body, it can seriously damage health when it is taken in large quantity or a natural mechanism for its metabolism is inhibited or deficient. Since histamine is produced as a result of food decay by microorganisms, it is used as a measure for food spoilage caused by microorganisms. The histamine contents by fermentation period were analyzed and the results are shown in Table 2 below.

TABLE 2
Comparison of histamine content in anchovy fish sauce
depending on fermentation method by fermentation period

Histamine

| Fermentation period | Control Group | Test group |
|---|---|---|
| (months) | (room temp.) | (constant temp., 45° C.) |
| 1 | 67.79 | 62.15 |
| 2 | 66.53 | 93 |
| 3 | 67.79 | 109 |
| 5 | 150.0 | — |
| 8 | 290.6 | — |
| 12 | 433.6 | — |

As shown in Table 2, the anchovy fish sauce manufactured according to the method of the present invention by rapid fermentation (test group) had a lower histamine content than the anchovy fish sauce manufactured by the traditional method (control group).

Specifically, the test group of the present invention (fermentation/ripening for 3 months) had a histamine content of 109 ppm while the anchovy fish sauce manufactured by fermenting at room temperature for 12 months according to the traditional method (fermentation/ripening for 12 months) had a histamine content of 433.6 ppm, about four times higher than that of the test group.

As a result, it was confirmed that the method of the present invention, wherein a salted marine product is fermented for the first time and then subjected to fermentation/ripening at constant temperature for 3 months after adding a crude fish sauce, can manufacture a fish sauce with a considerably lower degree of decay than a fish sauce manufactured by fermenting at room temperature according to the traditional method, thus providing high industrial value with advantages not only in reduced manufacturing time but also in improved quality.

### Example 4

### Sensory Test

A sensory test was performed to evaluate sensory preferences for the fish sauces manufactured as the test group (fermentation/ripening for 3 month) and the control group (fermentation/ripening for 12 month) as follows. Appearance preference, overall preference, flavor preference, texture preference, aftertaste preference, hot taste preference, salty taste preference, jeotgal flavor preference, savory taste preference, sweet taste preference, intensity of unpleasant taste/foul odor, etc. were evaluated. The sensory test was performed by 50 panelists of target consumers who were actually using the products (full-time housewives, female, 25-40 years, Seoul/Gyeonggi residents in Korea) via 9-point scaling according to the quantitative consumer acceptance test. The results are shown in Table 3 below.

TABLE 3
Sensory Test

| | Control | Test | |
|---|---|---|---|
| Evaluation items | group | group | p-value |
| Appearance preference | 6.04 | 6.31 | 0.186 |
| Overall preference | 5.81 | 6.10 | 0.221 |
| Flavor preference | 5.71 | 6.16 | 0.045 |
| Texture preference | 6.13 | 6.14 | 0.990 |
| Aftertaste preference | 6.00 | 5.80 | 0.351 |
| Jeotgal flavor preference | 5.48 | 6.50 | 0.011 |
| Hot taste preference | 6.21 | 6.08 | 0.500 |
| Salty taste preference | 5.48 | 5.69 | 0.575 |
| Sweet taste preference | 5.19 | 5.51 | 0.428 |
| Savory taste preference | 5.79 | 5.37 | 0.499 |
| Intensity of jeotgal flavor | 5.79 | 5.37 | 0.050 |
| Intensity of hot taste | 5.44 | 5.41 | 0.834 |
| Intensity of salty taste | 5.87 | 5.69 | 0.301 |
| Intensity of sweet taste | 5.90 | 5.82 | 0.639 |
| Intensity of savory taste | 5.33 | 5.22 | 0.500 |
| Intensity of unpleasant taste/foul odor | 1.15 | 1.14 | 0.908 |

* 9-point scaling (n = 50), 1 point: “very poor”, 5 points: “not good, not bad”, 9 points: “very good”.

As shown in Table 3, the anchovy fish sauce manufactured by rapid fermentation at constant temperature after adding the crude fish sauce to the ground fish according to the present invention (test group) was superior in appearance, flavor, jeotgal flavor, salty taste and overall preferences as compared to the anchovy fish sauce manufactured according to the traditional method (control group).

To summarize the results, the quality of the fish sauce manufactured according to the present invention was rather superior to the fish sauce manufactured by the traditional method although it was manufactured within a very short period of time.

From the foregoing, a skilled person in the art to which the present invention pertains will be able to understand that the present invention may be embodied in other specific forms without modifying the technical concepts or essential characteristics of the present invention. In this regard, the exemplary embodiments disclosed herein are only for illustrative purposes and should not be construed as limiting the scope of the present invention. On the contrary, the present invention is intended to cover not only the exemplary embodiments but also various alternatives, modifications, equivalents and other embodiments that may be included within the spirit and scope of the present invention as defined by the appended claims.

What is claimed is:

1. A method for manufacturing a fish sauce, comprising:
(a) adding salt to a ground marine product or a marine product, and mixing and homogenizing the mixture;
(b) performing first fermentation of the mixed homogenate obtained in step (a);
(c) adding a crude fish sauce to the first fermentation product obtained in step (b) and mixing the mixture; and
(d) ripening the mixture obtained in step (c) by performing fermentation.

2. The method for manufacturing a fish sauce according to claim 1, wherein step (d) is performed at constant temperature.

3. The method for manufacturing a fish sauce according to claim 1, wherein step (d) is performed by fermenting the mixture obtained in step (c), in an airtight sealed container at constant temperature.

4. The method for manufacturing a fish sauce according to claim 3, wherein step (d) is performed at a constant temperature of 20-60° C. for from 15 days to 12 months.

5. The method for manufacturing a fish sauce according to claim 3, wherein step (d) is performed at a constant temperature of 5-30° C. for from 6 months or longer.

6. The method for manufacturing a fish sauce according to claim 1, wherein the method for manufacturing a fish sauce further comprises, before step (a):
(i) removing water from a washed marine product; and
ii) grinding or not grinding the water-removed marine product.

7. The method for manufacturing a fish sauce according to claim 6, wherein, in step (ii), the marine product is ground to a size of 0.5-1.5 cm.

8. The method for manufacturing a fish sauce according to claim 1, wherein, in step (a), the salt is added in an amount of 17-30% (w/w) based on the weight of the ground marine product or the marine product.

9. The method for manufacturing a fish sauce according to claim 1, wherein, in step (b), the first fermentation is performed at 20-30° C. for from 1 day to 3 months.

10. The method for manufacturing a fish sauce according to claim 1, wherein, in step (c), the crude fish sauce is added in an amount of 1-30% (w/w) based on the weight of the mixed homogenate.

11. The method for manufacturing a fish sauce according to claim 3, wherein the airtight sealed container is selected from a group consisting of a polyethylene (PE) tank, a stainless steel tank, a fiber-reinforced plastic (FRP) tank, an earthenware, a glass container and a plastic container.

12. The method for manufacturing a fish sauce according to claim 2, wherein, step (d) is performed in a space which is maintained at constant temperature by hot air or warm air.

13. The method for manufacturing a fish sauce according to claim 1, wherein the marine product in step (a) is selected from a group consisting of pacific sand lance, anchovy, horse mackerel, squid, octopus, mackerel pike, sardine, tuna, tuna cooking juice, shrimp, Mysidae, Japanese ice fish, herring, gizzard shad, mackerel, Trachurus japonicus, yellowtail, pond smelt, and a combination thereof.

14. The method for manufacturing a fish sauce according to claim 1, wherein the crude fish sauce is prepared by adding salt to a marine product, mixing the mixture, ripening by performing fermentation for 6-12 months or longer, and then filtering.

15. The method for manufacturing a fish sauce according to claim 1, which further comprises, after step (d), heat-treating the fish sauce manufactured in step (d) at 60-100° C. for 10-30 minutes and then cooling.

16. A fish sauce prepared by the method for manufacturing a fish sauce according to claim 1.
